(19) United States
(12) Patent Application Publication
(10) Pub. No.: US 2023/0357483 A1
(43) Pub. Date: Nov. 9, 2023

(54) THERMOPLASTIC ALIPHATIC POLYURETHANE POLYMER HAVING A LOWER CRYSTALLIZATION ENTHALPY

(71) Applicant: Covestro Intellectual Property GmbH & Co. KG, Leverkusen (DE)

(72) Inventors: Bernd GARSKA, Köln (DE); Dirk DIJKSTRA, Köln (DE); Manfred WILHELM, Weingarten/Baden (DE)

(21) Appl. No.: 17/780,651

(22) PCT Filed: Dec. 10, 2020
(86) PCT No.: PCT/EP2020/085513

§ 371 Date: May 27, 2022

(30) Foreign Application Priority Data
Dec. 17, 2019 (EP) 19216785.6

(51) Int. Cl. C08G 18/10; C08G 18/32; C08G 18/73

(52) U.S. Cl. CPC C08G 18/10; C08G 18/3206; C08G 18/73

(57) ABSTRACT

The present invention relates to thermoplastic aliphatic polyurethane polymers, in which the ratio M̅_{z}/M̅_{w} is in a range from 2.3 to 6 and which have a degree of crystallinity χ in the range from 10% to 51%, to compositions containing such polyurethane polymers, to a method for the production thereof and to the use of these polyurethane polymers.

The present invention relates to thermoplastic aliphatic polyurethane polymers in which the ratio M̅_{z}/M̅_{w}, is in a range from 2.3 to 6 and which have a degree of crystallinity χ in the range from 10% to 51%, to compositions containing such polyurethane polymers, to a process for preparing same and to the use of these polyurethane polymers.

Owing to their excellent physical properties, polyurethanes and especially thermoplastic polyurethanes have been used for a wide variety of different end uses for many years. In spite of the broad usability of polyurethanes, there are fields of application in which other plastics, for example polyamide plastics, are used because there are no polyurethanes having suitable physical properties available or these can be provided only with difficulty.

Polyurethanes formed from short-chain aliphatic diols and short-chain aliphatic polyisocyanates have properties comparable to or better than the polyamide plastics, for example with regard to the paintability of the plastic. Thermoplastic polyurethane polymers which have a lower enthalpy of crystallization and lower crystallization temperature compared to comparable thermoplastic polyurethane polymers having the same melting point are particularly desirable since less energy is released during crystallization, i.e. the crystallinity is lower. The lower crystallinity results in a lower shrinkage and hence a higher dimensional stability in the further processing/extrusion/injection molding of such thermoplastic polyurethane polymers.

EP1846526A1 discloses crystalline or semi-crystalline oligomers or polymers and also compositions containing these oligomers and polymers for powder coatings. The oligomers and polymers are polyurethanes or polyesters which include at least one polyether and also UV-curable acrylate groups or thermally curable diol groups.

EP2004720A1 discloses polyurethane obtainable by reacting polyisocyanates with branched polyols and diols, and a process for its preparation. The document describes polyurethane formed from pentane-1,5-diol, trimethylolpropane and 4,4-methylenebis(cyclohexyl isocyanate), which has a degree of crystallinity of 42% after aging at 25° C. for 7 months.

EP0433823A1 discloses crystalline isocyanate compositions obtainable from a hydrogenated diphenylmethane diisocyanate and 2-methylpropane-1,3-diol.

None of the documents describes thermoplastic aliphatic polyurethane polymers.

A problem in the preparation of thermoplastic aliphatic polyurethane polymers is that the high density of reactive groups means that the polyaddition of short-chain aliphatic diols with aliphatic polyisocyanates has a high exothermicity/enthalpy of reaction which, in the event of inadequate removal of heat, results in damage, for example by discoloration, up to and including reformation of the monomers and destruction (ashing) of the polyurethane polymer.

An object of the present invention is to provide a thermoplastic aliphatic polyurethane polymer having a lower enthalpy of crystallization and a lower crystallization temperature than a comparable thermoplastic aliphatic polyurethane polymer, and also a process for the preparation thereof.

This object has been achieved by a thermoplastic aliphatic polyurethane polymer, characterized in that the ratio M̅_{z}/M̅_{w} of the thermoplastic aliphatic polyurethane polymer is in a range from 2.3 to 6, where M̅_{z} is the centrifuge-average molar mass and M̅_{w} is the mass-average molar mass, in each case determined by gel permeation chromatography, in which the sample was dissolved in a solution of potassium trifluoroacetate in hexafluoroisopropanol at a concentration of 2 mg/cm³ and a polymethylmethacrylate standard was used, and the thermoplastic aliphatic polyurethane polymer has a degree of crystallinity χ in the range from 10% to 51%, where the degree of crystallinity χ is determined according to the following equation:

χ=(ΔH_{C,polymer}/ΔH_{crystal,100%})·100%,

where ΔH_{C,polymer} is the measured enthalpy of crystallization in [J/g] of the thermoplastic aliphatic polyurethane polymer, determined by differential scanning calorimetry in accordance with DIN EN ISO 11357-1:2017-02 at a cooling rate of 10 K/min in the range from 250° C. to 20° C., and ΔH_{crystal,100%} is the measured enthalpy of fusion of the corresponding 100%-crystalline thermoplastic aliphatic polyurethane polymer in [J/g], determined by differential scanning calorimetry and X-ray scattering analysis. For this purpose, the enthalpy of fusion of the sample is measured by differential scanning calorimetry (DSC) and the crystallinity of the sample is determined by means of X-ray scattering. The enthalpy of fusion is preferably determined by differential scanning calorimetry. The ratio of the two values then corresponds to ΔH_{crystal,100%}, according to the literature (Kajiyama, T.; MacKnight, W J; Polymer Journal, volume 1, 548-554 (1970)).

It has surprisingly been found that the thermoplastic aliphatic polyurethane polymers of the invention have a much lower enthalpy of crystallization and crystallization temperature than comparable thermoplastic polyurethane polymers having the same melting point and prepared by a conventional batch process. As a result, the energy released during the crystallization of the polyurethane polymer of the invention is lower than in comparable non-inventive polyurethane polymers, and this has the advantage that there is lower shrinkage and hence higher dimensional stability during further processing, for example extrusion or injection molding. This furthermore has the advantage that the energy required to melt the thermoplastic aliphatic polyurethane polymers of the invention is much lower than for comparable thermoplastic polyurethane polymers. The broad processing window due to the lower crystallization temperature is advantageous when the polymer has to be kept in the molten state for a relatively long time during the processing, such as for example is the case for large injection molded components, in micro injection molding or, as experience has shown, in extrusion foaming.

In the context of the present invention, the word “a” in association with countable parameters should be understood to mean the number “one” only when this is stated explicitly (for instance by the expression “exactly one”). When reference is made hereinafter to “a polyol”, for example, the word “a” should be regarded merely as the indefinite article and not the number “one”, meaning that an embodiment comprising a mixture of at least two polyols is also encompassed.

“Aliphatic” or “aliphatic radical” are understood in the context of the invention to mean acyclic saturated hydrocarbon radicals that are branched or linear and preferably unsubstituted. These aliphatic hydrocarbon radicals preferably contain 2, 3, 4, 5 or 6 carbon atoms. The aliphatic polyurethane according to the invention has been formed from polyols and polyisocyanates each having acyclic saturated hydrocarbon skeletons, for example 1,6-diisocyanatohexane (HDI) and butane-1,4-diol (BDO).

The thermoplastic aliphatic polyurethane according to the invention preferably consists essentially of unbranched linear polymer chains, more preferably essentially of unbranched linear unsubstituted polymer chains, where the polymer chains do not contain any cycloaliphatic groups. The thermoplastic aliphatic polyurethane according to the invention is a thermoplastic aliphatic acyclic polyurethane. What is meant by “essentially” in this connection is that at least 95 mol %, preferably at least 98 mol %, particularly preferably at least 99 mol % and more preferably still at least 99.5 mol % of the polymer chains of the thermoplastic aliphatic polyurethane consists of unbranched linear polymer chains, preferably unbranched linear unsubstituted polymer chains, where the polymer chains do not contain any cycloaliphatic groups.

According to the invention, the terms “comprising” or “containing” preferably mean “consisting essentially of” and particularly preferably mean “consisting of”.

The degree of crystallinity χ is determined by means of differential scanning calorimetry (DSC, Q2000 instrument, TA Instruments) in accordance with DIN EN ISO 11357-1:2017-02 at a cooling rate of 10 K/min in the range from 250° C. to 20° C. and is ascertained according to the following equation:

χ=(ΔH_{C,polymer}/ΔH_{crystal,100%})·100%,

where ΔH_{C,polymer} is the measured enthalpy of crystallization in [J/g] of the thermoplastic aliphatic polyurethane polymer, determined by differential scanning calorimetry in accordance with DIN EN ISO 11357-1:2017-02 at a cooling rate of 10 K/min in the range from 250° C. to 20° C. under a nitrogen atmosphere and ΔH_{crystal,100%} is the measured enthalpy of fusion of the corresponding 100%-crystalline thermoplastic aliphatic polyurethane polymer in [J/g], determined by differential scanning calorimetry and X-ray scattering analysis. For this purpose, the enthalpy of fusion of the sample is measured by differential scanning calorimetry (DSC), preferably using differential scanning calorimetry and the crystallinity of the sample is determined by means of X-ray scattering. The ratio of the two values then corresponds to ΔH_{crystal,100%}, according to the literature (Kajiyama, T.; MacKnight, W J; Polymer Journal, volume 1, 548-554 (1970)).

For a polymer formed from 1,6-diisocyanatohexane (HDI) and butane-1,4-diol, the literature (Kajiyama, T.; MacKnight, W. J.; Polymer Journal, volume 1, 548-554 (1970)) has ascertained a value for ΔH_{crystal,100%} of 188 J/g, determined by the method described above.

Unless explicitly stated otherwise, in the present invention, the centrifuge-average molar mass M̅_{z′}, the mass-average molar mass M̅_{w} and the number-average molar mass M̅ₙ are determined by gel permeation chromatography (GPC) using polymethylmethacrylate as standard. The sample to be analyzed is dissolved in a solution of 3 g of potassium trifluoroacetate in 400 cubic centimeters of hexafluoroisopropanol (sample concentration about 2 mg/cubic centimeter), then applied via a pre-column at a flow rate of 1 cubic centimeter/minute and then separated by means of three series-connected chromatography columns, first by means of a 1000 Å PSS PFG 7 μm chromatography column, then by means of a 300 Å PSS PFG 7 μm chromatography column and lastly by means of a 100 Å PSS PFG 7 μm chromatography column The detector used was a refractive index detector (RI detector).

The centrifuge-average molar mass (M̅_{z}) was calculated from the data obtained by the gel permeation chromatography measurement with the aid of the following equation:

$${\overline{M}}_{z} = \frac{{\sum }_{i} {n}_{i} {M}_{i}^{3}}{{\sum }_{i} {n}_{i} {M}_{{i}^{2}}}$$

in g/mol
where:
Mᵢ is the molar mass of the polymers of the fraction i, such that Mᵢ<Mᵢ₊₁ for all i, in g/mol, nᵢ is the molar amount of the polymer of the fraction i, in mol.

The mass-average molar mass (M̅_{w}) was likewise calculated from the data obtained by the gel permeation chromatography measurement with the aid of the following equation:

$${\overline{M}}_{w} = \frac{{\sum }_{i} {n}_{i} {M}_{i}^{2}}{{\sum }_{i} {n}_{i} {M}_{i}}$$

in g/mol
where:
Mᵢ is the molar mass of the polymers of the fraction i, such that Mᵢ<Mᵢ₊₁ for all i, in g/mol, nᵢ is the molar amount of the polymer of the fraction i, in mol.

The number-average molar mass M̅ₙ was likewise calculated from the data obtained by the gel permeation chromatography measurement with the aid of the following equation:

$${\overline{M}}_{n} = \frac{{\sum }_{i} {n}_{i} {M}_{i}}{{\sum }_{i} {n}_{i}}$$

in g/mol
where:
Mᵢ is the molar mass of the polymers of the fraction i, such that Mᵢ<Mᵢ₊₁ for all i, in g/mol, nᵢ is the molar amount of the polymer of the fraction i, in mol.

Unless explicitly stated otherwise, the crystallization temperature is determined by means of differential scanning calorimetry (DSC, Q2000 instrument, TA Instruments) in accordance with DIN EN ISO 11357-1:2017-02 at a cooling rate of 10 K/min in the range from 250° C. to 20° C. Two heatings and a cooling in the range from 20° C. to 250° C. with a heating/cooling rate of 10 K/min are performed. The peak minimum of the DSC cooling curve (exothermically downward) is defined as the crystallization temperature.

A preferred embodiment relates to a thermoplastic aliphatic polyurethane polymer obtained or obtainable by reacting one or more aliphatic polyisocyanates with one or more aliphatic polyols and with at least one chain extender, wherein, in a first step, at least one or more aliphatic polyisocyanates are reacted with one or more aliphatic polyols, optionally in the presence of a catalyst and/or auxiliaries and additives, to give at least one prepolymer, preferably to give at least one hydroxy-terminated prepolymer, and the at least one prepolymer obtained in the first step is reacted in a second step with at least one chain extender, preferably at least one polyisocyanate, particularly preferably at least one diisocyanate, to give the thermoplastic polyurethane polymer, characterized in that the ratio M̅_{z}/M̅_{w} of the thermoplastic aliphatic polyurethane polymer is in a range from 2.3 to 6, where M̅_{z} is the centrifuge-average molar mass and M̅_{w} is the mass-average molar mass, in each case determined by gel permeation chromatography, in which the sample was dissolved in a solution of potassium trifluoroacetate in hexafluoroisopropanol at a concentration of 2 mg/cm³ and a polymethylmethacrylate standard was used, and the thermoplastic aliphatic polyurethane polymer has a degree of crystallinity χ in the range from 10% to 51%, where the degree of crystallinity χ is determined according to the following equation:

χ=(ΔH_{C,polymer}ΔH_{crystal,100%})·100%,

where ΔH_{C,polymer} is the measured enthalpy of crystallization in [J/g] of the thermoplastic aliphatic polyurethane polymer, determined by differential scanning calorimetry in accordance with DIN EN ISO 11357-1:2017-02 at a cooling rate of 10 K/min in the range from 250° C. to 20° C., and ΔH_{crystal,100%} is the measured enthalpy of fusion of the corresponding 100%-crystalline thermoplastic aliphatic polyurethane polymer in [J/g], determined by differential scanning calorimetry and X-ray scattering analysis.

In a preferred embodiment, the reaction is effected in a loop reactor.

A preferred embodiment relates to a thermoplastic aliphatic polyurethane polymer obtained or obtainable by reacting one or more aliphatic polyisocyanates with one or more aliphatic polyols, optionally in the presence of at least one catalyst and/or auxiliaries and additives, in a process comprising the following steps:
a) mixing a polyisocyanate stream (A) and a polyol stream (B) in a first mixing device (7), so as to obtain a mixed stream (C),
b) introducing the mixed stream (C) into a circulation stream (D) which is circulated, wherein the monomers of the polyisocyanate stream (A) and of the polyol stream (B) react further in the circulation stream (D) to give OH-functional prepolymers,
c) separating a substream from circulation stream (D) as prepolymer stream (E) and introducing it into an extruder (18),
d) introducing an isocyanate feed stream (F) into the extruder (18) downstream of the introduction of the prepolymer stream (E) in the working direction of the extruder,
   reacting the prepolymer stream (E) with the isocyanate feed stream (F) in the extruder (18) to obtain the thermoplastic polyurethane (G) as extrudate,
   characterized in that the ratio M̅_{z}/M̅_{w} of the thermoplastic aliphatic polyurethane polymer is in a range from 2.3 to 6, where M̅_{z} is the centrifuge-average molar mass and M̅_{w} is the mass-average molar mass, in each case determined by gel permeation chromatography, in which the sample was dissolved in a solution of potassium trifluoroacetate in hexafluoroisopropanol at a concentration of 2 mg/cm³ and a polymethylmethacrylate standard was used, and the thermoplastic aliphatic polyurethane polymer has a degree of crystallinity χ in the range from 10% to 51%, where the degree of crystallinity χ is determined according to the following equation:

χ=(ΔH_{C,polymer}/ΔH_{crystal,100%})·100%,

where ΔH_{C,polymer} is the measured enthalpy of crystallization in [J/g] of the thermoplastic aliphatic polyurethane polymer, determined by differential scanning calorimetry in accordance with DIN EN ISO 11357-1:2017-02 at a cooling rate of 10 K/min in the range from 250° C. to 20° C., and ΔH_{crystal,100%} is the measured enthalpy of fusion of the corresponding 100%-crystalline thermoplastic aliphatic polyurethane polymer in [J/g], determined by differential scanning calorimetry and X-ray scattering analysis.

In a preferred embodiment, the thermoplastic aliphatic polyurethane polymer according to the invention has a degree of crystallinity χ in the range from 20% to 51%, preferably in the range from 30% to 50%, particularly preferably in the range from 40% to 50% and more preferably still in the range from 45% to 50%.

In a further preferred embodiment, the ratio M̅_{w}/M̅ₙ of the thermoplastic aliphatic polyurethane polymer according to the invention is in a range from 3 to 8, preferably in a range from 4 to 6, particularly preferably in a range from 4.5 to 6, where M̅ₙ is the number-average molar mass and M̅_{w} is the mass-average molar mass, in each case determined by gel permeation chromatography, in which the sample was dissolved in a solution of potassium trifluoroacetate in hexafluoroisopropanol at a concentration of 2 mg/cm³ and a polymethylmethacrylate standard was used.

In a further preferred embodiment, the ratio M̅_{z}/M̅_{w} of the thermoplastic aliphatic polyurethane polymer according to the invention is in a range from 2.5 to 5, preferably in a range from 2.5 to 4, where M̅_{z} is the centrifuge-average molar mass and M̅_{w} is the mass-average molar mass, in each case determined by gel permeation chromatography, in which the sample was dissolved in a solution of potassium trifluoroacetate in hexafluoroisopropanol at a concentration of 2 mg/cm³ and a polymethylmethacrylate standard was used.

To prepare the thermoplastic aliphatic polyurethane polymers according to the invention, one or more aliphatic polyisocyanates are reacted with one or more aliphatic polyols.

Suitable aliphatic polyisocyanates are all aliphatic polyisocyanates known to those skilled in the art, in particular monomeric aliphatic diisocyanates. Suitable compounds are preferably those in the molecular weight range from ≥140 g/mol to ≤400 g/mol, it being immaterial whether these have been obtained by phosgenation or by phosgene-free methods. The polyisocyanates and/or the precursor compounds thereof may have been obtained from fossil or biological sources. Preference is given to preparing 1,6-diisocyanatohexane (HDI) from hexamethylene-1,6-diamine and 1,5-diisocyanatopentane from pentamethylene-1,5-diamine, with hexamethylene-1,6-diamine and pentamethylene-1,5-diamine having been obtained from biological sources, preferably by bacterial fermentation.

Examples of suitable aliphatic diisocyanates are 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,8-diisocyanatooctane and 1,10-diisocyanatodecane.

Further diisocyanates that are likewise suitable can additionally be found, for example, in Houben-Weyl “Methoden der organischen Chemie” [Methods of Organic Chemistry], volume E20 “Makromolekulare Stoffe” [Macromolecular Materials], Georg Thieme Verlag, Stuttgart, New York 1987, pp. 1587-1593 or in Justus Liebigs Annalen der Chemie volume 562 (1949) pp. 75-136.

In the context of the present invention, the term “monomeric diisocyanate” is understood to mean a diisocyanate not having dimeric, trimeric, etc. structures, being part of dimeric, trimeric, etc. structures, and/or a product of the reaction of an NCO group with an NCO-reactive group, for example urethane, urea, carbodiimide, acylurea, amide, isocyanurate, allophanate, biuret, oxadiazinetrione, uretdione and/or iminooxadiazinedione structures.

In a preferred embodiment, the one or more aliphatic polyisocyanates are selected from the group consisting of 1,4-diisocyanatobutane, 1,5-diisocyanatopentane, 1,6-diisocyanatohexane, 2-methyl-1,5-diisocyanatopentane and/or mixtures of at least two of these. In another preferred embodiment, 1,5-diisocyanatopentane and/or 1,6-diisocyanatohexane are used as aliphatic polyisocyanates. In a further preferred embodiment, solely 1,6-diisocyanatohexane is used as aliphatic polyisocyanate.

Suitable as aliphatic polyols are all organic diols known to those skilled in the art that have a molecular weight of from 62 g/mol to 210 g/mol, preferably diols that have a molecular weight in the range from 62 g/mol to 120 g/mol. The diols and/or the precursor compounds thereof may have been obtained from fossil or biological sources. The aliphatic diols for formation of the thermoplastic polyurethane polymer according to the invention are preferably selected from the group consisting of ethane-1,2-diol, propane-1,2-diol, propane-1,3-diol, butane-1,2-diol, butane-1,3-diol, butane-1,4-diol, pentane-1,2-diol, pentane-1,3-diol, pentane-1,4-diol, pentane-1,5-diol, hexane-1,2-diol, hexane-1,3-diol, hexane-1,4-diol, hexane-1,5-diol and hexane-1,6-diol, or a mixture of at least two of these. Preferably, no branched aliphatic diols are used.

In a preferred embodiment, the one or more aliphatic diols are selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol and/or mixtures of at least two of these. In a further preferred embodiment, propane-1,3-diol, butane-1,4-diol, hexane-1,6-diol and/or mixtures of at least two of these are used as aliphatic diols. In a further preferred embodiment, butane-1,4-diol and/or hexane-1,6-diol are used as aliphatic diols. In another preferred embodiment, solely butane-1,4-diol is used as aliphatic diol.

In a further preferred embodiment, the thermoplastic aliphatic polyurethane polymer according to the invention is obtainable by reacting one or more aliphatic polyisocyanates having a molecular weight in the range from ≥140 g/mol to ≤400 g/mol, preferably one or more aliphatic diisocyanates having a molecular weight in the range from 140 g/mol to 170 g/mol, with one or more aliphatic polyols, preferably one or more aliphatic diols having a molecular weight in the range from 62 g/mol to 210 g/mol, particularly preferably one or more aliphatic diols having a molecular weight in the range from 62 g/mol to 120 g/mol.

In a further preferred embodiment, the thermoplastic aliphatic polyurethane polymer according to the invention consists to an extent of at least 80% by weight, preferably to an extent of at least 90% by weight, particularly preferably to an extent of at least 95% by weight, more preferably to an extent of at least 98% by weight, more preferably still to an extent of at least 99% by weight, and most preferably to an extent of at least 99.9% by weight, of the reaction product of the reaction of hexamethylene 1,6-diisocyanate with butane-1,4-diol, based on the total mass of the thermoplastic aliphatic polyurethane polymer. When determining the proportion of the reaction product of the reaction of hexamethylene-1,6-diisocyanate with butane-1,4-diol, only the polymeric constituents are taken into account, based on the total mass of the polymeric thermoplastic aliphatic polyurethane polymer.

In a further preferred embodiment, the thermoplastic aliphatic polyurethane polymer according to the invention has a peak crystallization temperature in the range from 130° C. to 145° C., preferably a peak crystallization temperature in the range from 140° C. to 145° C., determined by differential scanning calorimetry (DSC) in accordance with DIN EN ISO 11357-1:2017-02.

A further subject of the invention relates to a process for preparing a thermoplastic aliphatic polyurethane polymer according to the invention, wherein, in a first step, at least one or more aliphatic polyisocyanates are reacted with one or more aliphatic polyols, optionally in the presence of a catalyst and/or auxiliaries and additives, to give at least one prepolymer, preferably to give at least one hydroxy-terminated prepolymer, and the at least one prepolymer obtained in the first step is reacted in a second step with at least one chain extender, preferably at least one polyisocyanate, particularly preferably at least one diisocyanate, to give the thermoplastic aliphatic polyurethane polymer.

The molar NCO/OH ratio is preferably in the range from 0.95:1.00 to 1.05:1.00.

In a preferred embodiment of the process according to the invention, independently of one another, as aliphatic polyisocyanate, an aliphatic diisocyanate is used, preferably an aliphatic polyisocyanate is used selected from the group consisting of 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,8-diisocyanatooctane, 1,10-diisocyanatodecane and/or mixtures of at least 2 of these, particularly preferably an aliphatic polyisocyanate is used selected from the group consisting of 1,4-diisocyanatobutane (BDI), 1,5-diisocyanatopentane (PDI), 1,6-diisocyanatohexane (HDI) and/or mixtures of at least 2 of these, and more preferably still the aliphatic polyisocyanate used is 1,6-diisocyanatohexane (HDI), and, as aliphatic polyol, an aliphatic diol is used, preferably an aliphatic polyol is used selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol, heptane-1,7-diol, octane-1,8-diol, nonane-1,9-diol and/or mixtures of at least 2 of these, particularly preferably an aliphatic polyol is used selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol and/or mixtures of at least 2 of these, more preferably still the aliphatic polyol used is butane-1,4-diol.

In a preferred embodiment of the process according to the invention, the aliphatic polyisocyanate used is 1,6-diisocyanatohexane (HDI) and the aliphatic polyol used is butane-1,4-diol.

The reaction of the one or more aliphatic polyisocyanates with one or more aliphatic polyols to produce the thermoplastic aliphatic polyurethane polymer according to the invention may take place in the presence of one or more catalysts.

Suitable catalysts according to the invention are the customary tertiary amines known from the prior art, for example triethylamine, dimethylcyclohexylamine, N-methylmorpholine, N,N′-dimethylpiperazine, 2-(dimethylaminoethoxy)ethanol, diazabicyclo [2.2.2]octane and the like, and also in particular organic metal compounds such as titanic esters, iron compounds, tin compounds, e.g. tin diacetate, tin dioctoate, tin dilaurate or the dialkyltin salts of aliphatic carboxylic acids such as dibutyltin diacetate, dibutyltin dilaurate or the like. Preferred catalysts are organic metal compounds, in particular titanic esters, iron compounds and/or tin compounds.

The catalyst is used in amounts of 0.001% by weight to 2.0% by weight, preferably of 0.005% by weight to 1.0% by weight, particularly preferably of 0.01% by weight to 0.1% by weight, based on the diisocyanate component. The catalyst can be used in neat form or dissolved in the diol component. One advantage here is that the thermoplastic polyurethanes that are then obtained do not contain any impurities as a result of any solvents for the catalyst that are additionally used. The catalyst can be added in one or more portions or else continuously, for example with the aid of a suitable metering pump, over the entire duration of the reaction.

However, it is alternatively possible also to use mixtures of the catalyst(s) with a catalyst solvent, preferably with an organic catalyst solvent. The degree of dilution of the catalyst solutions is freely choosable within a very wide range. Solutions are catalytically active above a concentration of 0.001% by weight.

Suitable solvents for the catalyst are, for example, solvents that are inert toward isocyanate groups, for example hexane, toluene, xylene, chlorobenzene, ethyl acetate, butyl acetate, diethylene glycol dimethyl ether, dipropylene glycol dimethyl ether, ethylene glycol monomethyl or monoethyl ether acetate, diethylene glycol ethyl and butyl ether acetate, propylene glycol monomethyl ether acetate, 1-methoxy-2-propyl acetate, 3-methoxy-n-butyl acetate, propylene glycol diacetate, acetone, methyl ethyl ketone, methyl isobutyl ketone, cyclohexanone, lactones, such as β-propiolactone, γ-butyrolactone, ε-caprolactone and ε-methylcaprolactone, but also solvents such as N-methylpyrrolidone and N-methylcaprolactam, 1,2-propylene carbonate, methylene chloride, dimethyl sulfoxide, triethyl phosphate or any desired mixtures of such solvents.

However, it is also possible to use solvents for the catalyst that bear groups reactive toward isocyanates and can be incorporated into the diisocyanate. Examples of such solvents are mono- or polyhydric simple alcohols, for example methanol, ethanol, n-propanol, isopropanol, n-butanol, n-hexanol, 2-ethyl- 1-hexanol, ethylene glycol, propylene glycol, the isomeric butanediols, 2-ethylhexane-1,3-diol or glycerol; ether alcohols, for example 1-methoxy-2-propanol, 3-ethyl-3-hydroxymethyloxetane, tetrahydrofurfuryl alcohol, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol, dipropylene glycol or else liquid higher-molecular-weight polyethylene glycols, polypropylene glycols, mixed polyethylene/polypropylene glycols and the monoalkyl ethers thereof; ester alcohols, for example ethylene glycol monoacetate, propylene glycol monolaurate, glycerol mono- and diacetate, glycerol monobutyrate or 2,2,4-trimethylpentane-1,3-diol monoisobutyrate; unsaturated alcohols, for example allyl alcohol, 1,1-dimethyl allyl alcohol or oleyl alcohol; araliphatic alcohols, for example benzyl alcohol; N-monosubstituted amides, for example N-methylformamide, N-methylacetamide, cyanoacetamide or 2-pyrrolidone, or any desired mixtures of such solvents.

Auxiliaries and additives used may for example be standard auxiliaries and additives in the field of thermoplastics technology, such as dyes, fillers, processing aids, plasticizers, nucleating agents, chain terminators such as monoalcohols, monoamines and monoisocyanates, stabilizers, flame retardants, demolding agents or reinforcing auxiliaries and additives. Further details on the auxiliaries and additives mentioned may be found in the specialist literature, for example in the monograph by J. H. Saunders and K. C. Frisch “High Polymers”, volume XVI, Polyurethane [Polyurethanes], parts 1 and 2, Interscience Publishers 1962 and 1964, in “Taschenbuch für Kunststoff-Additive” [Plastics Additives Handbook] by R. Gächter and H. Müller (Hanser Verlag Munich 1990) or in DE-A 29 01 774. It will be self-evident that it can likewise be advantageous to use a plurality of auxiliaries and additives of a plurality of types.

In the context of the present invention, a “hydroxy-terminated prepolymer” is understood to mean a prepolymer mixture in which at least 90% (by number) of the ends of the molecule have a hydroxy group and the remaining 10% (by number) of ends of the molecule have further hydroxy groups, NCO groups or non-reactive groups. A “non-reactive group” in the context of the present invention is understood to mean a group that, under the reaction conditions of the invention, reacts neither with NCO groups nor with OH groups within a unit of time that corresponds to the reaction time according to the invention. A non-reactive group may, for example, be converted from a reactive NCO group or OH group through reaction with suitable co-reactants (chain terminators) to form a non-reactive group. Suitable chain terminators are all monofunctional compounds that under the reaction conditions of the invention react either with an isocyanate group or with a hydroxy group, for example monoalcohols such as methanol, monoamines such as diethylamine, and monoisocyanates such as butyl isocyanate. The hydroxy-terminated prepolymer may, for example, have a hydroxy group at one end of the molecule and, for example, an alkyl group at the other end(s) of the molecule. Where reference is made to a hydroxy-terminated prepolymer in the context of the present invention, this always also encompasses a mixture of the at least one hydroxy-terminated prepolymer and a non-reactively terminated prepolymer. In addition, based on the statistics of the reaction, disregarding side reactions, it may also be a mixture of non-hydroxy-terminated up to doubly hydroxy-terminated prepolymers. It is preferably a mixture predominantly of doubly hydroxy-terminated prepolymers. According to the invention, the at least one hydroxy-terminated prepolymer may also be a mixture of at least one hydroxy-terminated prepolymer and at least one non-reactively terminated prepolymer.

In the context of the present invention, a “non-reactively terminated prepolymer” is understood to mean a prepolymer in which the reactive groups (NCO groups or OH groups) have been converted by reaction with suitable co-reactants (chain terminators) to chemical groups that do not react either with NCO groups or with OH groups under the reaction conditions mentioned. Examples of suitable chain terminators are monoalcohols such as methanol, monoamines such as diethylamine, and monoisocyanates such as butyl isocyanate. The molar proportion of the chain terminators may, for example, be from 0.001 mol % to 2 mol % and preferably from 0.002 mol % to 1 mol %, based in each case on the total molar amount of the corresponding monomer component.

The at least one hydroxy-terminated prepolymer may for example be formed from the entirety of the aliphatic polyols and a first portion of the aliphatic polyisocyanates. In one or more subsequent steps, further portions of the aliphatic polyisocyanates, i.e. a second, third etc. portion, may then be added in order to form further hydroxy-terminated prepolymers, on average of higher molecular weight, according to the invention. Alternatively, the at least one hydroxy-terminated prepolymer may be formed, for example, from a first portion of the aliphatic polyols and a first portion of the aliphatic polyisocyanates. In one or more subsequent process stages, further portions of the aliphatic polyols and of the aliphatic polyisocyanates may then be fed in in order to form further hydroxy-terminated prepolymers, on average of higher molecular weight.

The reaction can be performed with or without catalyst, but preference is given to a catalyzed reaction. Suitable catalysts are the catalysts listed above. The reaction can be effected in a solvent-free manner or in solution. What is meant by “in solution” is that at least one of the co-reactants is dissolved in a solvent before being added to the other co-reactant. Preference is given to performing the reaction in a solvent-free manner. In the context of the present invention, the process is still considered to be solvent-free when the solvent content is up to 1% by weight, preferably up to 0.1% by weight, even more preferably up to 0.01% by weight, based on the total weight of the reaction mixture.

The temperatures for formation of the at least one prepolymer, preferably hydroxy-terminated prepolymer, by the process according to the invention can be selected depending on the compounds used. However, it is preferable here when the reaction is conducted at temperatures of ≥40° C. to ≤260° C., preferably of ≥60° C. to ≤250° C., more preferably of ≥100° C. to ≤240° C., especially preferably of ≥120° C. to ≤220° C. In this context, brief (<60 seconds) deviations in the reaction temperature from the abovementioned ranges experienced by the product during the reaction are tolerated.

The at least one prepolymer thus produced, preferably hydroxy-terminated prepolymer, may, for example, be reacted in at least one further process stage with at least one chain extender to give the thermoplastic polyurethane polymer. It is possible here to react either the entireties of the two components, i.e. of the at least one prepolymer produced, preferably hydroxy-terminated prepolymer, and of the at least one chain extender, with one another in one process stage, or to react a portion of one component with the entirety or a portion of the other component in multiple process stages. Preference is given to using one or more aliphatic diisocyanates having a molecular weight of 140 g/mol to 170 g/mol as chain extender.

If the prepolymer is a hydroxy-terminated prepolymer, it can be reacted with hydroxy-reactive chain extenders such as for example polyisocyanates. Suitable polyisocyanates are all polyisocyanates known to those skilled in the art. Preference is given to using one or more aliphatic diisocyanates having a molecular weight of 140 g/mol to 170 g/mol as chain extender. If the prepolymer is an NCO-terminated prepolymer, it can be reacted with NCO-reactive chain extenders such as for example organic diols, thiols, diamines, and mixtures of at least two of these. Suitable organic diols, thiols and diamines are known to those skilled in the art. The reaction of the prepolymer with the chain extender to form the polymer can be effected for example in an extruder.

The temperatures for formation of the thermoplastic polyurethane polymer according to the invention by reaction of the at least one prepolymer, preferably hydroxy-terminated prepolymer, with the at least one chain extender in the process according to the invention may be selected depending on the compounds used. However, it is preferable here when the reaction is conducted at temperatures of ≥60° C. to ≤260° C., preferably of ≥80° C. to ≤250° C., particularly preferably of ≥100° C. to ≤245° C. and very particularly preferably of ≥120° C. to ≤240° C. In this context, brief (<60 seconds) deviations in the reaction temperature from the abovementioned ranges experienced by the product during the reaction are tolerated.

The process stages for production of the thermoplastic aliphatic polyurethane polymer according to the invention can be performed in a single apparatus or in a multitude of apparatuses. For example, the production of the prepolymer, preferably hydroxy-terminated prepolymer, can first be conducted in a first apparatus (e.g. loop reactor or coolable mixer) and then the reaction mixture can be transferred into a further apparatus (e.g. extruder or other high-viscosity reactor) in order to produce the thermoplastic aliphatic polyurethane polymer according to the invention.

In a further preferred embodiment, the reaction of the at least one prepolymer, preferably hydroxy-terminated prepolymer, with the at least one chain extender takes place in an extruder.

In a further preferred embodiment, the preparation of the thermoplastic aliphatic polyurethane polymer according to the invention takes place in a combination of a loop reactor with an extruder.

In a further preferred embodiment, the preparation of the thermoplastic aliphatic polyurethane polymer according to the invention takes place in a combination of a static mixer, dynamic mixer, loop reactor or mixer-heat transferrer with a heated conveyor belt.

After the reaction to give the thermoplastic aliphatic polyurethane polymer according to the invention, it is converted to a commercial form, typically pellets. After the conversion in the final process stage, the thermoplastic aliphatic polyurethane polymer according to the invention is in the molten state, is comminuted in the molten state and is made to solidify by cooling, or is first made to solidify by cooling and then comminuted. This can be accomplished, for example, by the methods of strand pelletization, underwater strand pelletization, water-ring pelletization and underwater pelletization that are known to the person skilled in the art. Cooling is preferably effected with water; cooling with air or other media is also possible.

After conversion in a belt reactor, the thermoplastic aliphatic polyurethane polymer according to the invention can also be cooled, crushed and ground.

According to the invention, the thermoplastic aliphatic polyurethane polymer according to the invention thus obtained can be mixed in a solid-state mixing process and melted and pelletized again in a further extruder. This is preferable particularly when the thermoplastic aliphatic polyurethane polymer according to the invention is cooled and ground downstream of the belt reactor because this operation also homogenizes the product form.

The preparation process according to the invention can be performed continuously or batchwise, i.e. as a batchwise process or semibatchwise process.

A further embodiment of the invention relates to a thermoplastic aliphatic polyurethane polymer obtainable or obtained by the process according to the invention.

A further embodiment of the invention relates to a composition containing at least one thermoplastic aliphatic polyurethane polymer according to the invention and at least one additive and/or a further thermoplastic polymer. Suitable additives are all additives and auxiliaries mentioned above. Suitable thermoplastic polymers that may be part of the composition according to the invention are, for example, polystyrenes, polyamides, polyethylene, polypropylene, polyacrylates, polymethacrylates, polyurethanes or else acrylonitrile-butadiene-styrene copolymers (ABS).

The compositions according to the invention can be used to produce thermoplastic molding compounds. The invention therefore further provides a thermoplastic molding compound comprising at least one composition according to the invention. The thermoplastic molding compounds according to the invention may be produced, for example, by mixing the respective constituents of the compositions in a known manner and melt-compounding and melt-extruding the constituents at temperatures of preferably 180° C. to 320° C., particularly preferably at 200° C. to 300° C., in customary apparatuses, for example internal kneaders, extruders and twin-shaft screw systems. This process is referred to in the context of the present application generally as compounding.

What is meant by “molding compound” is thus the product obtained when the constituents of the composition are melt-compounded or melt-extruded.

The individual constituents of the compositions can be mixed in a known manner, either successively or simultaneously, either at about 20° C. (room temperature) or at higher temperature. This means that, for example, some of the constituents may be introduced via the main intake of an extruder and the remaining constituents may be introduced later in the compounding process via a side extruder.

The invention also provides a process for the production of the molding compounds according to the invention.

The thermoplastic molding compounds according to the invention may be used to produce moldings, films and/or fibers of any kind. The invention therefore further provides a molding, a film and/or a fiber, wherein the molding, film or fiber comprises at least one thermoplastic polyurethane polymer according to the invention, at least one thermoplastic molding compound according to the invention or at least one composition according to the invention. These may be produced, for example, by injection molding, extrusion, blow-molding methods and/or melt spinning A further form of processing is the production of moldings by thermoforming from previously produced sheets or films.

It is also possible to meter the constituents of the compositions directly into an injection molding machine or into an extrusion unit and to process them to give moldings.

The invention further provides for the use of a thermoplastic polyurethane polymer according to the invention, of a thermoplastic molding compound according to the invention or of a composition according to the invention for the production of a molding, a film and/or a fiber.

The invention further provides for the use of a thermoplastic polyurethane polymer according to the invention for the production of a composition, a thermoplastic molding compound or a polyurethane dispersion.

The invention further provides an article comprising or containing a thermoplastic molding compound according to the invention or a composition according to the invention.

The invention especially relates to the following embodiments:

In a first embodiment, the invention relates to a thermoplastic aliphatic polyurethane polymer, characterized in that the ratio M̅_{z}/M̅_{w} of the thermoplastic aliphatic polyurethane polymer is in a range from 2.3 to 6, where M̅_{z} is the centrifuge-average molar mass and M̅_{w} is the mass-average molar mass, in each case determined by gel permeation chromatography, in which the sample was dissolved in a solution of potassium trifluoroacetate in hexafluoroisopropanol at a concentration of 2 mg/cm³ and a polymethylmethacrylate standard was used, and the thermoplastic aliphatic polyurethane polymer has a degree of crystallinity χ in the range from 10% to 51%, where the degree of crystallinity χ is determined according to the following equation:

χ=(ΔH_{C,polymer}/ΔH_{crystal,100%})·100%,

where ΔH_{C,polymer} is the measured enthalpy of crystallization in [J/g] of the thermoplastic aliphatic polyurethane polymer, determined by differential scanning calorimetry (DSC) in accordance with DIN EN ISO 11357-1:2017-02 at a cooling rate of 10 K/min in the range from 250° C. to 20° C., and ΔH_{crystal,100%} is the enthalpy of fusion of the corresponding 100%-crystalline thermoplastic aliphatic polyurethane polymer in [J/g], determined by differential scanning calorimetry and X-ray scattering analysis.

In a second embodiment, the invention relates to a thermoplastic aliphatic polyurethane polymer according to embodiment 1, wherein the thermoplastic aliphatic polyurethane polymer has a degree of crystallinity χ in the range from 20% to 51%, preferably in the range from 30% to 50%, particularly preferably in the range from 40% to 50% and more preferably still in the range from 45% to 50%.

In a third embodiment, the invention relates to a thermoplastic aliphatic polyurethane polymer according to either of embodiments 1 and 2, wherein the ratio M̅_{w}/M̅ₙ of the thermoplastic aliphatic polyurethane polymer is in a range from 3 to 8, preferably in a range from 4 to 6, particularly preferably in a range from 4.5 to 6, where M̅ₙ is the number-average molar mass and M̅_{w} is the mass-average molar mass, in each case determined by gel permeation chromatography, in which the sample was dissolved in a solution of potassium trifluoroacetate in hexafluoroisopropanol at a concentration of 2 mg/cm³ and a polymethylmethacrylate standard was used.

In a fourth embodiment, the invention relates to a thermoplastic aliphatic polyurethane polymer according to any of embodiments 1 to 3, wherein the ratio M̅_{z}/M̅_{w} of the thermoplastic aliphatic polyurethane polymer is in a range from 2.5 to 5, preferably in a range from 2.5 to 4, where M̅_{z} is the centrifuge-average molar mass and M̅_{w} is the mass-average molar mass, in each case determined by gel permeation chromatography, in which the sample was dissolved in a solution of potassium trifluoroacetate in hexafluoroisopropanol at a concentration of 2 mg/cm³ and a polymethylmethacrylate standard was used.

In a fifth embodiment, the invention relates to a thermoplastic aliphatic polyurethane polymer according to any of embodiments 1 to 4, wherein the thermoplastic aliphatic polyurethane polymer is obtainable by reacting one or more aliphatic polyisocyanates having a molecular weight in the range from ≥140 g/mol to ≤400 g/mol, preferably one or more aliphatic diisocyanates having a molecular weight in the range from 140 g/mol to 170 g/mol, with one or more aliphatic polyols, preferably one or more aliphatic diols having a molecular weight in the range from 62 g/mol to 210 g/mol, particularly preferably one or more aliphatic diols having a molecular weight in the range from 62 g/mol to 120 g/mol.

In a sixth embodiment, the invention relates to a thermoplastic aliphatic polyurethane polymer according to any of embodiments 1 to 5, wherein the thermoplastic aliphatic polyurethane polymer consists to an extent of at least 80% by weight, preferably to an extent of at least 90% by weight, particularly preferably to an extent of at least 95% by weight, more preferably to an extent of at least 98% by weight, more preferably still to an extent of at least 99% by weight, and most preferably to an extent of at least 99.9% by weight, of the reaction product of the reaction of hexamethylene-1,6-diisocyanate with butane-1,4-diol, based on the total mass of the thermoplastic aliphatic polyurethane polymer.

In a seventh embodiment, the invention relates to a thermoplastic aliphatic polyurethane polymer according to any of embodiments 1 to 6, wherein the thermoplastic aliphatic polyurethane polymer has a peak crystallization temperature in the range from 130° C. to 145° C., preferably a peak crystallization temperature in the range from 140° C. to 145° C., determined by differential scanning calorimetry (DSC) in accordance with DIN EN ISO 11357-1:2017-02.

In an eighth embodiment, the invention relates to a process for preparing a thermoplastic aliphatic polyurethane polymer according to any of embodiments 1 to 7, characterized in that, in a first step, at least one or more aliphatic polyisocyanates are reacted with one or more aliphatic polyols, optionally in the presence of a catalyst and/or auxiliaries and additives, to give at least one prepolymer, preferably to give at least one hydroxy-terminated prepolymer, and the at least one prepolymer obtained in the first step is reacted in a second step with at least one chain extender, preferably at least one polyisocyanate, particularly preferably at least one diisocyanate, to give the thermoplastic aliphatic polyurethane polymer.

In a ninth embodiment, the invention relates to a process according to embodiment 8, wherein, as aliphatic polyisocyanate, an aliphatic diisocyanate is used, preferably an aliphatic polyisocyanate is used selected from the group consisting of 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,8-diisocyanatooctane, 1,10-diisocyanatodecane and/or mixtures of at least 2 of these, particularly preferably an aliphatic polyisocyanate is used selected from the group consisting of 1,4-diisocyanatobutane (BDI), 1,5-diisocyanatopentane (PDI), 1,6-diisocyanatohexane (HDI) and/or mixtures of at least 2 of these, and more preferably still the aliphatic polyisocyanate used is 1,6-diisocyanatohexane (HDI).

In a tenth embodiment, the invention relates to a process according to either of embodiments 8 and 9, wherein, as aliphatic polyol, an aliphatic diol is used, preferably an aliphatic polyol is used selected from the group consisting of ethane-1,2-diol, propane-1,2-diol, propane-1,3-diol, butane-1,2-diol, butane -1,3 -diol, butane-1,4-diol, pentane -1,5 -diol, hexane-1,6-diol, heptane-1,7-diol, octane-1,8-diol, nonane-1,9-diol and/or mixtures of at least 2 of these, particularly preferably an aliphatic polyol is used selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol and/or mixtures of at least 2 of these, more preferably still the aliphatic polyol used is butane-1,4-diol.

In an eleventh embodiment, the invention relates to a process according to any of embodiments 8 to 10, wherein the process is conducted in a loop reactor or in a mixer, preferably in a static mixer, particular preference being given to conducting the process according to the invention in a loop reactor.

In a twelfth embodiment, the invention relates to a process according to any of embodiments 8 to 11, wherein the process is a continuous process.

In a thirteenth embodiment, the invention relates to a process according to any of embodiments 8 to 12, wherein the process is a solvent-free process.

In a fourteenth embodiment, the invention relates to a process according to any of embodiments 8 to 13, wherein the preparation of the at least one prepolymer, preferably to give at least one hydroxy-terminated prepolymer, is effected without a catalyst.

In a fifteenth embodiment, the invention relates to a process according to any of embodiments 8 to 14, wherein the at least one prepolymer is reacted, without a catalyst, in a second step with at least one chain extender, preferably at least one polyisocyanate, particularly preferably at least one diisocyanate, to give the thermoplastic aliphatic polyurethane polymer.

In a sixteenth embodiment, the invention relates to a thermoplastic aliphatic polyurethane polymer obtainable or obtained by a process according to any of embodiments 8 to 15.

In a seventeenth embodiment, the invention relates to a composition containing at least one thermoplastic aliphatic polyurethane polymer according to any of embodiments 1 to 7 and at least one additive and/or a further thermoplastic polymer.

In an eighteenth embodiment, the invention relates to a thermoplastic molding compound, characterized in that it comprises at least one composition according to embodiment 17.

In a nineteenth embodiment, the invention relates to a molding, film and/or fiber, characterized in that the molding, film or fiber comprises at least one thermoplastic polyurethane polymer according to any of embodiments 1 to 7, at least one thermoplastic molding compound according to embodiment 18 or at least one composition according to embodiment 17.

In a twentieth embodiment, the invention relates to the use of a thermoplastic polyurethane polymer according to any of embodiments 1 to 7, a thermoplastic molding compound according to embodiment 18 or a composition according to embodiment 17 for the production of a molding, film and/or fiber.

In a twenty-first embodiment, the invention relates to the use of a thermoplastic polyurethane polymer according to any of embodiments 1 to 7 for the production of a composition, a thermoplastic molding compound or a polyurethane dispersion.

In a twenty-second embodiment, the invention relates to an article comprising or containing a thermoplastic polyurethane polymer according to any of embodiments 1 to 7 or a composition according to embodiment 17.

In a twenty-third embodiment, the invention relates to a thermoplastic aliphatic polyurethane polymer according to any of embodiments 1 to 7, obtained or obtainable by reacting one or more aliphatic polyisocyanates with one or more aliphatic polyols and with at least one chain extender, wherein, in a first step, at least one or more aliphatic polyisocyanates are reacted with one or more aliphatic polyols, optionally in the presence of a catalyst and/or auxiliaries and additives, to give at least one prepolymer, preferably to give at least one hydroxy-terminated prepolymer, and the at least one prepolymer obtained in the first step is reacted in a second step with at least one chain extender, preferably at least one polyisocyanate, particularly preferably at least one diisocyanate, to give the thermoplastic polyurethane polymer, characterized in that the ratio M̅_{z}/M̅_{w} of the thermoplastic aliphatic polyurethane polymer is in a range from 2.3 to 6, where M̅_{z} is the centrifuge-average molar mass and M̅_{w} is the mass-average molar mass, in each case determined by gel permeation chromatography, in which the sample was dissolved in a solution of potassium trifluoroacetate in hexafluoroisopropanol at a concentration of 2 mg/cm³ and a polymethylmethacrylate standard was used, and the thermoplastic aliphatic polyurethane polymer has a degree of crystallinity χ in the range from 10% to 51%, where the degree of crystallinity χ is determined according to the following equation:

χ=(ΔH_{C,polymer}/ΔH_{crystal,100%})·100%,

where ΔH_{C,polymer} is the measured enthalpy of crystallization in [J/g] of the thermoplastic aliphatic polyurethane polymer, determined by differential scanning calorimetry in accordance with DIN EN ISO 11357-1:2017-02 at a cooling rate of 10 K/min in the range from 250° C. to 20° C., and ΔH_{crystal,100%} is the measured enthalpy of fusion of the corresponding 100%-crystalline thermoplastic aliphatic polyurethane polymer in [J/g], determined by differential scanning calorimetry and X-ray scattering analysis.

In a twenty-fourth embodiment, the invention relates to a thermoplastic aliphatic polyurethane polymer obtained or obtainable by reacting one or more aliphatic polyisocyanates with one or more aliphatic polyols, optionally in the presence of at least one catalyst and/or auxiliaries and additives, in a process comprising the following steps:
a) mixing a polyisocyanate stream (A) and a polyol stream (B) in a first mixing device (7), so as to obtain a mixed stream (C),
b) introducing the mixed stream (C) into a circulation stream (D) which is circulated, wherein the monomers of the polyisocyanate stream (A) and of the polyol stream (B) react further in the circulation stream (D) to give OH-functional prepolymers,
c) separating a substream from circulation stream (D) as prepolymer stream (E) and introducing it into an extruder (18),
d) introducing an isocyanate feed stream (F) into the extruder (18) downstream of the introduction of the prepolymer stream (E) in the working direction of the extruder,
   reacting the prepolymer stream (E) with the isocyanate feed stream (F) in the extruder (18) to obtain the thermoplastic polyurethane (G) as extrudate,
   characterized in that the ratio M̅_{z}/M̅_{w} of the thermoplastic aliphatic polyurethane polymer is in a range from 2.3 to 6, where M̅_{z} is the centrifuge-average molar mass and M̅_{w} is the mass-average molar mass, in each case determined by gel permeation chromatography, in which the sample was dissolved in a solution of potassium trifluoroacetate in hexafluoroisopropanol at a concentration of 2 mg/cm³ and a polymethylmethacrylate standard was used, and the thermoplastic aliphatic polyurethane polymer has a degree of crystallinity χ in the range from 10% to 51%, where the degree of crystallinity χ is determined according to the following equation:

χ=(ΔH_{C,polymer}/ΔH_{crystal,100%})·100%,

where ΔH_{C,polymer} is the measured enthalpy of crystallization in [J/g] of the thermoplastic aliphatic polyurethane polymer, determined by differential scanning calorimetry in accordance with DIN EN ISO 11357-1:2017-02 at a cooling rate of 10 K/min in the range from 250° C. to 20° C., and ΔH_{crystal,100%} is the measured enthalpy of fusion of the corresponding 100%-crystalline thermoplastic aliphatic polyurethane polymer in [J/g], determined by differential scanning calorimetry and X-ray scattering analysis.

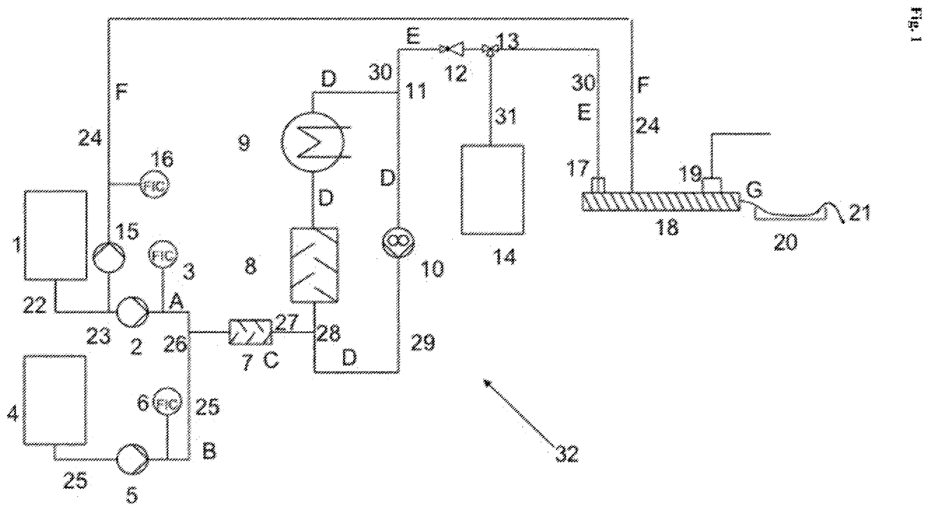

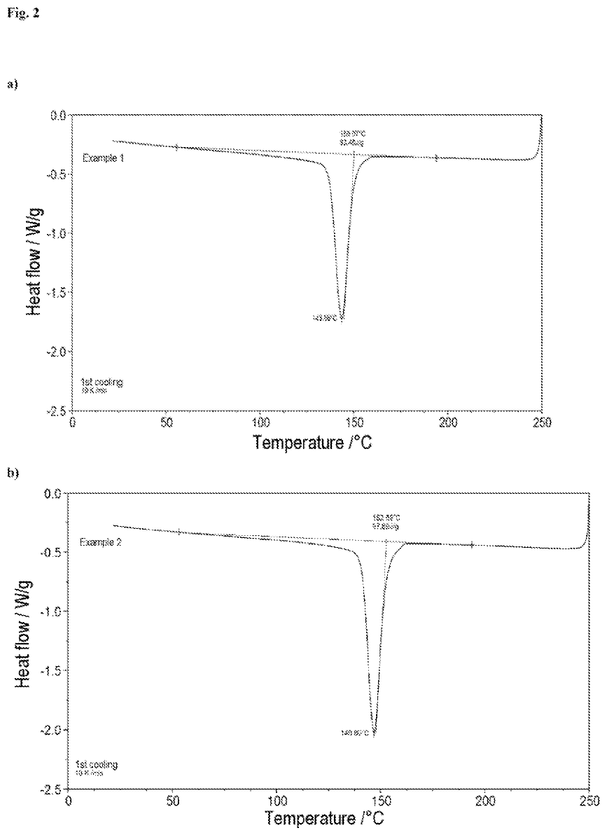

The present invention is more particularly elucidated hereinbelow with reference to FIGS. 1 and 2. These figures show:

FIG. 1 shows an apparatus for performing the process according to the invention, and

FIG. 2 is a thermogram from a differential thermal analysis of a polyurethane which
a) was prepared by the process according to the invention and
b) was prepared by a process not in accordance with the invention.

### EXAMPLES

The present invention is elucidated further by the examples that follow, but without being restricted thereto.

Two thermoplastic polyurethane polymers, which had been prepared by different synthesis methods, were compared with one another, during which the enthalpy of fusion and the molecular weight of these two polyurethane polymers were analyzed.

### Determination of the Enthalpy of Crystallization

The enthalpy of crystallization is determined by means of differential scanning calorimetry (DSC) on the basis of DIN EN ISO 11357-1:2017-02. The measurement was effected on a Q2000 instrument (TA Instruments). Two heatings and a cooling in the range from 20° C. to 250° C. with a heating/cooling rate of 10 K/min were performed. The sample mass was about 6 mg. The purge gas flow (nitrogen) was 50 ml/min.

### Determination of the Molecular Weight

GPC method for the determination of Mₙ and M_{w}:

The number-average and the mass-average molar mass were determined using gel permeation chromatography (GPC), in which the sample to be analyzed was dissolved in a solution of potassium trifluoroacetate in hexafluoroisopropanol at a concentration of 2 mg/cm³ and a polymethylmethacrylate standard was used.
Pump: 515 HPLC pump (Waters GmbH)
Detector: Smartline 2300 RI detector (Knauer Wissenschaftliche Gerate GmbH)
Columns: 1 precolumn, 1000 Å PSS PFG 7 μm, 300 Å PSS PFG 7 μm, 100 Å PSS PFG 7 μm in this sequence (PSS Polymer Standards Service GmbH)
Degassing: PSS Degasser (PSS Polymer Standards Service GmbH)
Injection volume: 100 microliters
Temperature: 23° C.-25° C.
Molar mass standard: Polymethylmethacrylate standard kit (PSS Polymer Standards Service GmbH)

Unless explicitly stated otherwise, in the present invention, the centrifuge-average molar mass M_{z} was determined by means of gel permeation chromatography (GPC) using polymethylmethacrylate as standard. The sample to be analyzed was dissolved in a solution of 3 g of potassium trifluoroacetate in 400 cubic centimeters of hexafluoroisopropanol (sample concentration about 2 mg/cubic centimeter), and then applied via a pre-column at a flow rate of 1 cubic centimeter/minute and then separated by means of three series-connected chromatography columns, first by means of a 1000 Å PSS PFG 7 μm chromatography column, then by means of a 300 Å PSS PFG 7 μm chromatography column and lastly by means of a 100 Å PSS PFG 7 μm chromatography column The detector used was a refractive index detector (RI detector). The number-average molecular weight was calculated from the data obtained by the gel permeation chromatography measurement with the aid of the following equation:

$${\overline{M}}_{n} = \frac{{\sum }_{i} {n}_{i} {M}_{i}}{{\sum }_{i} {n}_{i}} g / mol$$

where
Mᵢ is the molar mass of the polymers of the fraction i, such that Mᵢ<Mᵢ₊₁ for all i, in g/mol, nᵢ is the molar amount of the polymer of the fraction i, in mol.

The mass-average molar mass (M̅_{w}) was likewise calculated from the data obtained by the gel permeation chromatography measurement with the aid of the following equation:

$${\overline{M}}_{w} = \frac{{\sum }_{i} {n}_{i} {M}_{{i}^{2}}}{{\sum }_{i} {n}_{i} {M}_{i}} g / mol$$

where:
Mᵢ is the molar mass of the polymers of the fraction i, such that Mᵢ<Mᵢ₊₁ for all i, in g/mol, nᵢ is the molar amount of the polymer of the fraction i, in mol.

The centrifuge-average molecular weight was calculated from the data obtained by the gel permeation chromatography measurement with the aid of the following equation:

$${\overline{M}}_{z} = \frac{{\sum }_{i} {n}_{i} {M}_{i}^{3}}{{\sum }_{i} {n}_{i} {M}_{i}^{2}}$$

where
Mᵢ is the molar mass of the polymers of the fraction i, such that Mᵢ<Mᵢ₊₁ for all i, in g/mol, nᵢ is the molar amount of the polymer of the fraction i, in mol.

### Example 1 According to the Invention

An annular gear pump 2 (HNP, MZR 7255) was used to convey a polyisocyanate stream A consisting of hexamethylene 1,6-diisocyanate from a 250 liter reservoir 1 for hexamethylene 1,6-diisocyanate to a static mixer 7. The throughput of the polyisocyanate stream A was measured using a mass flow meter 3 (Bronkhorst, Mini Cori-Flow M1X, max. flow rate 12 kg/h). The temperature of the hexamethylene 1,6-diisocyanate was room temperature.

An annular gear pump 5 (HNP, MZR 7205) was used to convey a polyol stream B consisting of butane-1,4-diol from a 250 liter reservoir 4 for butane-1,4-diol to the static mixer 7. The throughput of the polyol stream B was measured using a mass flow meter 6 (Bronkhorst, Mini Con-Flow M1X, max. flow rate 8 kg/h). The temperature of the butane-1,4-diol was 40° C.

In the static mixer 7 (Sulzer SMX, diameter 6 mm, ratio of length to diameter L/D=10), polyisocyanate stream A and polyol stream B were mixed with one another so as to obtain a mixed stream C. The mass flow rates of the polyisocyanate stream A and of the polyol stream B were adjusted such that the isocyanate index in the mixed stream C was 78.

Mixed stream C was fed via a junction 28 into the circulation conduit 29 in which a circulation stream D was circulated. Downstream of the junction 28, the circulation stream D was guided into a static mixer 8 (static mixer equivalent to Sulzer SMX, internal diameter 34 mm, L/D=20). The temperature of prepolymer stream D was 182° C.

Downstream of static mixer 8, circulation stream D was guided into a temperature-controllable static mixer 9. The oligomerization of the circulation stream D with the mixed stream C took place there for the most part and the heat of reaction formed was removed. The temperature-controllable static mixer 9 was of similar construction to a Sulzer SMR reactor with internal crossed tubes. It had an internal volume of 1.9 liters and a heat exchange surface area of 0.44 square meters. It was heated/cooled with heat-transfer oil. The heating medium temperature at the inlet was 180° C.

The circulation stream D exited the temperature-controllable static mixer 9 at a temperature of 183° C. Downstream of the temperature-controllable static mixer 9, a prepolymer stream E was separated from circulation stream D at a junction 11, and the circulation stream D was guided onward to a gear pump 10. The prepolymer stream E was guided into an extruder 18.

The pressure of circulation stream D was increased in a gear pump 10. The gear pump 10 (Witte Chem 25, 6-3) had a volume per revolution of 25.6 cubic centimeters and a speed of 50 revolutions per minute. Circulation stream D was combined with mixed stream C downstream of the pump at junction 28, as already described.

Circulation conduit 29 consisted of jacketed pipe conduits heated with thermal oil. The heating medium temperature was 182° C. The static mixer 8, the temperature-controllable static mixer 9 and the gear pump 10 consisted of apparatuses heated with thermal oil. The heating medium temperature was 182° C.

The reactive extrusion was conducted in an extruder 18 at a temperature of 200° C. and a speed of 66 revolutions per minute. The extruder 18 was a ZSK 26 MC from Coperion, with a screw diameter of 26 mm and a length to diameter ratio of 36 to 40.

The extruder 18 had a venting means 17 that was operated at a negative pressure of about 1 mbar relative to standard pressure, and in which prepolymer stream E was freed of any inert gases entrained with the polyisocyanate stream A and the polyol stream B, and possible gaseous reaction products.

A micro annular gear pump 15 (MZR 6355 from HNP) was used to withdraw an isocyanate feed stream F consisting of hexamethylene 1,6-diisocyanate from reservoir 1. The throughput of the isocyanate feed stream F was measured by means of a mass flow meter 16 (Bronkhorst, Mini Cori-Flow M1X, maximum flow rate 2 kg/h). The temperature of the hexamethylene 1,6-diisocyanate was room temperature. Isocyanate feed stream F was guided into the extruder 18 downstream of prepolymer stream E. In the extruder 18, the prepolymer stream E was reacted with the isocyanate feed stream F at an isocyanate index of 99 to give a thermoplastic polyurethane G.

A devolatilizer 19 arranged in the last third of the extruder 18 in flow direction was used to free the thermoplastic polyurethane G of volatile constituents at 200 mbar below standard pressure with the aid of a vacuum dome arranged on top of a devolatilization shaft of the extruder. The thermoplastic polyurethane G after exiting from the extruder 18 through two nozzles was cooled in a water bath 20 filled with deionized water (DM water) and chopped into pellets by means of a pelletizer 21.

TABLE 1
Material streams in the preparation of the TPU in example 1

| | [kg/h] |
|---|---|
| Stream A (HDI) | 2.911 |
| Stream B (BDO) | 2.000 |
| Stream J (HDI) | 0.784 |
| Stream E (prepolymer) | 120 |

### Reference Example 2

In a stirred tank (250 ml), 24.59 g of butane-1,4-diol was heated to 90° C. while stirring (170 revolutions per minute (rpm)) and with introduction of nitrogen, for 30 minutes. Subsequently, 45.39 g of HDI was metered continuously into the butanediol over a period of 45 minutes. In the course of this, the temperature of the reaction mixture was increased constantly by 4° C. per minute until a temperature of 190° C. had been attained (25 minutes). As soon as a product temperature of 190° C. had been attained, the stirrer speed was increased to 300 rpm. The temperature in the stirred tank was kept constant between 190° C. and 200° C.

After the metered addition of HDI had ended, the melt was stirred for a further 5 minutes. Subsequently, it was poured into an aluminum mold in the hot state.

### Results

The enthalpy of fusion and the molecular weights of the thermoplastic polyurethanes obtained from examples 1 and 2 were analyzed by the methods described above. The results are compiled in table 2:

TABLE 2
Enthalpy of fusion and molecular weight
of the polyurethanes obtained

| | Example 1 according | Comparative |
|---|---|---|
| | to the invention | example 2 |
| M_{w} [g/mol] | 58510 | 60020 |
| M_{w}/Mₙ | 4.97 | 2.55 |
| M_{z}/M_{w} | 2.71 | 2.05 |
| Enthalpy of crystallization ΔH_{C} | 93.5 | 97.7 |
| [J/g] | | |
| Onset crystallization | 150.1 | 152.7 |
| temperature [C. °] | | |
| Peak crystallization | 143.6 | 146.8 |
| temperature [C. °] | | |
| ΔH_{crystal, 100%} [J/g] | 188 | 188 |
| Degree of crystallinity χ [%] | 49.7 | 52.0 |

The DSC thermograms of the two materials analyzed are shown in FIG. 2. The thermoplastic polyurethanes from examples 1 and 2 each have a mass-average molecular weight in a similar range of 58 000 g/mol to approx. 60 000 g/mol and also have similar melting temperatures in the range from 183° C. to 186° C. However, the TPU according to the invention has an enthalpy of crystallization that is 4.3% lower compared to the TPU of the comparative example. Due to the lower enthalpy of crystallization of the TPU according to the invention, in the further processing by melting and subsequent shaping less energy needs to be supplied for the melting than for the further processing of the TPU from the comparative example. If the same amount of energy is used to melt the thermoplastic polyurethanes from each of the two examples, the TPU according to the invention melts quicker. The thermoplastic polyurethane of the invention furthermore has the advantage that, compared to the example not in accordance with the invention, it leads to lower shrinkage and hence to higher dimensional stability during further processing, for example extrusion or injection molding.

1. A thermoplastic aliphatic polyurethane polymer, wherein the ratio M̅_{z}/M̅_{w} of the thermoplastic aliphatic polyurethane polymer is in a range from 2.3 to 6, where M̅_{z} is the centrifuge-average molar mass and M̅_{w} is the mass-average molar mass, in each case determined by gel permeation chromatography, in which the sample was dissolved in a solution of potassium trifluoroacetate in hexafluoroisopropanol at a concentration of 2 mg/cm³ and a polymethylmethacrylate standard was used, and the thermoplastic aliphatic polyurethane polymer has a degree of crystallinity χ in the range from 10% to 51%, where the degree of crystallinity χ is determined according to the following equation:
χ=(ΔH_{C,polymer}/ΔH_{crystal,100%})·100%,
where ΔH_{C,polymer} is the measured enthalpy of crystallization in [J/g] of the thermoplastic aliphatic polyurethane polymer, determined by differential scanning calorimetry (DSC) in accordance with DIN EN ISO 11357-1:2017-02 at a cooling rate of 10 K/m in in the range from 250° C. to 20° C., and
ΔH_{crystal,100%} is the enthalpy of fusion of the corresponding 100%-crystalline thermoplastic aliphatic polyurethane polymer in [J/g], determined by differential scanning calorimetry and X-ray scattering analysis.

2. The thermoplastic aliphatic polyurethane polymer as claimed in claim 1, wherein the thermoplastic aliphatic polyurethane polymer has a degree of crystallinity χ in the range from 20% to 51%.

3. The thermoplastic aliphatic polyurethane polymer as claimed in claim 1, wherein the ratio M̅_{w}/M̅ₙ of the thermoplastic aliphatic polyurethane polymer is in a range from 3 to 8.
where M̅ₙ is the number-average molar mass and M̅_{w} is the mass-average molar mass, in each case determined by gel permeation chromatography, in which the sample was dissolved in a solution of potassium trifluoroacetate in hexafluoroisopropanol at a concentration of 2 mg/cm³ and a polymethylmethacrylate standard was used.

4. The thermoplastic aliphatic polyurethane polymer as claimed in claim 1, wherein the ratio M̅_{z}/M̅_{w} of the thermoplastic aliphatic polyurethane polymer is in a range from 2.5 to 5, where M̅_{z} is the centrifuge-average molar mass and M̅_{w} is the mass-average molar mass, in each case determined by gel permeation chromatography, in which the sample was dissolved in a solution of potassium trifluoroacetate in hexafluoroisopropanol at a concentration of 2 mg/cm³ and a polymethylmethacrylate standard was used.

5. The thermoplastic aliphatic polyurethane polymer as claimed in claim 1, wherein the thermoplastic aliphatic polyurethane polymer is obtained by reacting one or more aliphatic polyisocyanates having a molecular weight in the range from ≥140 g/mol to ≤400 g/mol, with one or more aliphatic polols.

6. The thermoplastic aliphatic polyurethane polymer as claimed in claim 1, wherein the thermoplastic aliphatic polyurethane polymer consists to an extent of at least 80% by weight of the reaction product of the reaction of hexamethylene-1,6-diisocyanate with butane-1,4-diol, based on the total mass of the thermoplastic aliphatic polyurethane polymer.

7. The thermoplastic aliphatic polyurethane polymer as claimed in claim 1, characterized in that the thermoplastic aliphatic polyurethane polymer has a peak crystallization temperature in the range from 130° C. to 145° C., determined by differential scanning calorimetry (DSC) in accordance with DIN EN ISO 11357-1:2017-02.

8. A process for preparing a thermoplastic aliphatic polyurethane polymer as claimed in claim 1, wherein, in a first step, at least one or more aliphatic polyisocyanates are reacted with one or more aliphatic polyols, optionally in the presence of a catalyst and/or auxiliaries and additives, to give at least one prepolymer, and the at least one prepolymer obtained in the first step is reacted in a second step with at least one chain extender to give the thermoplastic aliphatic polyurethane polymer.

9. The process as claimed in claim 8, wherein, independently of one another, as aliphatic polyisocyanate, an aliphatic diisocyanate is used and, as aliphatic polyol, an aliphatic diol is used.

10. A composition comprising at least one thermoplastic aliphatic polyurethane polymer as claimed in claim 1 and at least one additive and/or a further thermoplastic polymer.

11. A thermoplastic molding compound, comprising at least one composition as claimed in claim 10.

12. A molding, film and/or fiber, comprising at least one thermoplastic polyurethane polymer as claimed in claim 1, at least one thermoplastic molding compound as claimed in claim 11, or at least one composition as claimed in claim 10.

13. A method of producing molding, film, and/or fiber, comprising producing the molding, film, and/or fiber with the thermoplastic polyurethane polymer as claimed in claim 1, a molding compound including the thermoplastic polyurethane polymer as claimed in claim 1, or composition including the thermoplastic polyurethane polymer as claimed in claim 1.

14. A method of producing a composition, a thermoplastic molding compound, or a polyurethane dispersion, comprising producing the composition, the thermoplastic molding compound, or the polyurethane dispersion with the thermoplastic aliphatic polyurethane polymer as claimed in claim 1.

15. An article comprising the thermoplastic aliphatic polyurethane polymer as claimed in claim 1 or a composition including the thermoplastic aliphatic polyurethane polymer as claimed in claim 1.
